(19) United States
(12) Patent Application Publication
(10) Pub. No.: US 2011/0233809 A1
(43) Pub. Date: Sep. 29, 2011

(54) GLASS-FILLED THREE-DIMENSIONAL RESIN ELEMENTS AND METHODS FOR MAKING THE SAME

(75) Inventors: Carole Carter, Las Vegas, NV (US); Ken Carter, Las Vegas, NV (US); Jennifer Bell, Las Vegas, NV (US); Nate Blanchard, Las Vegas, NV (US)

(73) Assignee: e-gads! LLC, Las Vegas, NV (US)

(21) Appl. No.: 13/045,201

(22) Filed: Mar. 10, 2011

Related U.S. Application Data
(60) Provisional application No. 61/312,587, filed on Mar. 10, 2010.

(51) Int. Cl. B29C 39/12; B29C 39/10

(52) U.S. Cl. 264/78; 264/279.1

(57) ABSTRACT

Methods of making three-dimensional glass tilled resin elements are provided. The methods can include the use of open or closed molds in a wide variety of shapes and sizes. The molds are filled with resin material and glass fragments to provide aesthetically pleasing three-dimensional resin elements. The resin material can be dyed to provide for a wide variety of colors, and the glass fragments can be obtained from post-consumer glass.

### BACKGROUND

Resin-based panels have previously been used for a variety of architectural and decorative purposes, including countertops, table tops, divider panels, back splashes, and wall coverings. Some resin-based panels include embedded glass fragments for additional decorative appeal. Applicants believe that these glass-filled resin-based panels are predominantly formed by laminating glass fragments between sheets of resin-based panels, such as through the use of a pultrusion or extrusion process.

In some typical pultrusion processes, glass fragments are pulled through a resin bath to fully coat the glass fragments with the resin material. The coated glass fragments are then passed through a heated die to cause polymerization of the polymers and form a hardened and cured resin-based panel having embedded glass fragments.

In some typical extrusion processes, a resin material having glass fragments dispersed therein is pushed or drawn through a die. As the material is pushed or drawn through the die, heat is applied so that the material exiting the die is a hardened and cured material having a cross section approximately equal to the shape of the die.

Applicants believe that there are several disadvantages to fabricating resin-based panels with embedded glass fragments in either of these manners. Firstly. the extrusion and pultrusion processes do not allow for the use of dyes in the resin material. Accordingly, the color of the resin-based panels produced by these methods is dependent on the color of the glass fragments embedded in the panels. Secondly, the pultrusion and extrusion processes are only capable of producing panels in a limited number of shapes and sizes. Applicants believe that pultrusion and extrusion processes are limited to producing essentially flat resin-based panels that are no larger than about four feet by eight feet. Accordingly, the extrusion and pultrusion processes cannot produce large resin-based panels in custom three-dimensional shapes. Correspondingly, the limitation to flat resin-based panels means that only a shallow layer of glass fragments can be embedded therein, which in turn limits the aesthetic appeal of the resin-based panels.

Furthermore, custom orders are difficult to fulfill using pultrusion and extrusion methods due to the generally continuous and bulk nature of each process. Finally, resin-based panels produced by pultrusion and extrusion processes have surface characteristics that are not easily repairable and that cannot be buffed without causing further damage to the resin-based panels.

### SUMMARY

Disclosed below are representative embodiments that are not intended to be limiting in any way. Instead, the present disclosure is directed toward novel and nonobvious features, aspects, and equivalents of the embodiments of the nozzle reactor and method of use described below. The disclosed features and aspects of the embodiments can be used alone or in various novel and nonobvious combinations and sub-combinations with one another.

In some embodiments, a method of making glass-filled three-dimensional resin elements includes a step of providing a mold of any desired three-dimensional shape and size. This mold is filled with resin material and glass fragments, and then cured to create solid resin structure having glass fragments embedded therein. The resin material used to make the glass-filled three-dimensional resin elements can be dyed any of a variety of colors prior to being poured in the mold such that the finished product is colored both by the resin material and the color of the glass fragments embedded therein.

This method of producing glass-filled three-dimensional resin elements is advantageous over previously known methods in that the size and shape of products produced by the method are not limited. To the contrary, previously known methods such as pultrusion and extrusion typically produce glass-filled resin elements of a limited size and in generally flat panel shapes. Additionally, the ability to dye the resin material in the method described herein usually is not possible in extrusion and pultrusion processes. Rather, the resins used in extrusion and pultrusion usually remain a clear, transparent color, thereby limiting the design options of the elements produced by these methods.

Another advantage of the method includes the ability to use recycled glass fragments in the three-dimensional elements, which thereby reduces waste. Additionally, the three-dimensional nature of the resin elements allows for relatively large amounts of post-consumer glass fragments to be included in the glass-filled three-dimensional resin elements, which both reduces waste and increase design options. Still another advantage of the method includes a highly customizable product that can be produced quickly with the preparation of just a single custom mold. Still another advantage includes the ability to correct any surface defects in the glass-filled three-dimensional resin elements via buffing, as opposed to elements produced by pultrusion and extrusion, which cannot be buffed without causing further damage to the elements.

There are other objects, advantages, and features of the present embodiments disclosed herein. They will become apparent as this specification proceeds. In this regard, the scope of the invention is not to be limited by the foregoing Background or Summary and is to be determined by the scope of the claims as issued .

### BRIEF DESCRIPTION OF THE DRAWINGS

The preferred and other embodiments are disclosed in association with the accompanying drawings in which:

FIG. 1 is a flow chart detailing a method for making glass-filled three-dimensional resin elements as disclosed herein;

FIG. 2A is a cross-sectional view of a mold used during various steps in a method for making glass-filled three-dimensional resin elements as disclosed herein; and

FIG. 2B a cross-sectional view of another mold used during various steps in a method for making glass-filled three-dimensional resin elements as disclosed herein.

### DETAILED DESCRIPTION

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

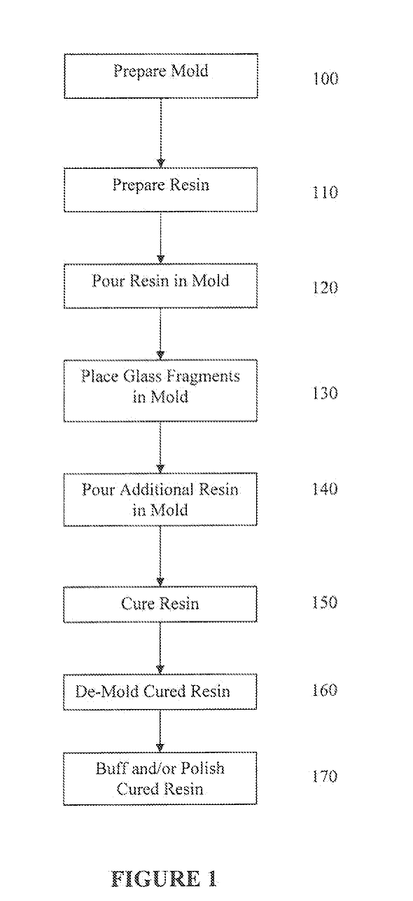

Methods of making glass-filled three-dimensional elements can generally include some or all of the steps illustrated in FIG. 1. These steps include a step 100 of preparing a mold, a step 110 of preparing a resin material, a step 120 of pouring the resin material into the mold, a step 130 of adding glass fragments into the mold, a step 140 of pouring additional resin material into the mold, a step 150 of curing the resin material in the mold, a step 160 of removing the glass-filled resin element from the mold, and a step 170 of buffing and/or polishing the glass-filled resin element.

The mold prepared in step 100 can be prepared using any manner of mold-making known to those of ordinary skill in the art. Exemplary materials suitable for use as a mold material include, but are not limited to, wood and silicone rubber. In the case where wood is selected as a mold material, a wood frame can be prepared and placed on a suitable surface, followed by filling the interior of the wood frame with resin material. The wood frame and surface on which it is placed contain the resin within a prescribed area and in the shape of the wood frame. Molds made from silicone rubber can serve a similar or identical function, although molds made from silicone rubber can include a bottom made from the same silicone rubber material as the containment walls of the mold.

The mold used in step 100 can be an open mold or a closed mold. Open molds include the wood frame and silicone rubber molds described above, wherein the mold remains open to the surrounding environment. Closed molds encase the resin material and any other material supplied therein. In some embodiments, closed molds are used in conjunction with a rotational casting machine that rotates the closed mold in different directions to result in the resin material and other materials spreading to every corner of the mold.

The molds used in step 100 can also have any shape or size, which can render a significant advantage over methods that require the use of an extrusion or pultrusion apparatus to manufacture glass-filled resin elements. While the extrusion and pultrusion methods are typically limited to producing flat or curved panels with a relatively thin cross section, molds used in step 100 can be any shape, including any of a variety of three-dimensional shapes. Exemplary three-dimensional shapes for the molds used in step 100 include spheres, pyramids, blocks, and any type of irregular three-dimensional shape, including curvilinear three-dimensional shapes. Similarly, while extrusion and pultrusion methods are typically limited to producing panels having a maximum size of about four feet by eight feet, the size of the molds used in the methods described herein can be any suitable size.

Once a suitable mold has been prepared in step 100, a step 110 of preparing a resin material is carried out. The resin material prepared in step 110 is used to fill the mold prepared in step 100 and encase glass fragments as part of the method of making the glass-filled three-dimensional elements described herein. Curing of the resin hardens the material and forms a solid structure having glass fragments embedded therein.

Any resin material in which glass fragments can be embedded and that can be hardened into a solid structure can be used in step 110. Typically, the resin used in methods described herein will be a thermosetting resin so that the resin can be cured to harden into a solid structure. Suitable resin materials include, but are not limited to, polyester resins, polyurethane reins, and epoxy resins. Specific examples of commercially available resins used in the methods described herein include, but are not limited to, SIL95BA-41, available from Revchem Composites of Van Nuys, Calif.; BJB WC-753, BJB WC-780, and BJB WC-783, available from BJB Enterprises of Tustin, Calif.; and IPI OC-7080 and IPI TD-275-16A, available from Innovative Polymers, Inc. of Saint Johns, Mich.

In some embodiments, the resin used can be a fire retardant resin. Use of such fire retardant resins can make the resulting three-dimensional element fire resistant and better suited for certain architectural uses, such as when the three-dimensional elements are used as panels for walls. Any suitable fire retardant resin can be used in the methods described herein. A non-exhaustive example of a commercially available fire retardant resin suitable for use in the methods described herein is IPI TD-275-16A resin, available from Innovative Polymers, Inc. of Saint Johns, Mich. This resin product has FR characteristics as part of the standard product.

Typically, the resin material is in a liquid form, although the resin material may also be in a solid pellet form that is converted into a liquid prior to use in the methods described herein. In some embodiments, the resin is a transparent material. The resin can remain transparent throughout the process, or a dye can be added to the transparent resin to make the finished product a three-dimensional element having a specifically selected color.

Preparation of the resin can include one or more of several preparation steps. In some preparation steps, the resin can be heated to either change a solid resin material into a liquid resin or to further reduce the viscosity of an already liquid resin material so that it is more flowable. Heating liquid resin material to reduce the viscosity can also aide in eliminating air bubbles from the resin material.

In some preparations steps, additional materials are mixed with the resin material to improve its overall ability to harden into a solid structure, including reducing the amount of time it takes for the resin material to harden. Additional ingredients that can be added to the resin material include liquid catalysts. Any suitable liquid catalyst can be used, including organic peroxide liquid resins. Liquid catalysts can be added to the resin material in any suitable amount. In some embodiments, the prepared resin material can range from about 0.5 wt % to about 2.5 wt % of liquid catalyst. Examples of commercially available catalysts that are suitable for use in the methods described herein include, but are not limited to, Hi-Point 90 MEKP (methyl ethyl ketone peroxide in a mixture of dimethyl phthalate and an ester plasticizer), available from PMI of Ontario, CA, and Norox MEKP 925 from Syrgis in Helena, Ark. In one example, the amount of Hi-Point MEKP catalyst added to the resin material is from 1.25% to 1.75% (1⅔ ounce to 2⅓ ounces per gallon).

In some preparations steps, one or more dyes are added to the transparent resin material to change the color of the resin. Any dyes suitable for changing the color of resin material can be used. Similarly, dyes of any available color can be used. Additionally, any quantity of dye necessary to change to the color of the resin material can be used.

In some embodiments, the dyes are dyes that are compatible with the resin typed used. For example, when polyester resin is used, the dye is preferably a polyester-compatible dye. Examples of commercially available dyes suitable for use in methods described herein include, but are not limited to, EP7701, available from Eager Polymers of Chicago, Ill., and Kosmic Kolor Urethane Enamel Kandys, available from House of Kolor of Picayune, Miss.

In some preparation steps, a fire retardant can be added to the resin to achieve a similar or identical result as when a fire retardant resin is used. Any suitable fire retardant can be added to the resin and the fire retardant can be added to the resin in any suitable amount. A non-exhaustive example of a commercially available fire retardant that may be added to a resin material is Alumina Trihydrate (ATH), available from JM Huber Corp. of Edison, N.J.

Some preparation steps can include a degassing step wherein air bubbles contained in the resin are removed. Removal of air bubbles from the resin material can be advantageous in order to provide a finished product with a more pleasing aesthetic appeal. Additionally, removal of air bubbles from the resin can result in a finished product that is more structurally sound then a finished product that includes air bubbles within the hardened material. Any suitable method for degassing the resin material can be used. As mentioned above, air bubbles can be removed from the resin material by heating the resin material and lowering the viscosity of the resin material. In some embodiments, a degassing step takes place by placing the resin material in a vacuum chamber. Any suitable vacuum chamber can be used to carry out the degassing, and the degassing step can be carried out for any period of time that is required to remove all or substantially all of the air bubbles from the resin material.

Once the resin is prepared as described above, a step 120 of pouring a quantity of the resin into the prepared mold is carried out. Any suitable manner of pouring the prepared resin into the mold can be used, and can be performed either manually or through the use of an automated machine. In some embodiments, the resin is poured into the mold slowly and at different locations in the mold to promote even distribution of the resin material throughout the mold.

While any suitable amount of resin can be poured into the mold in step 120, in some embodiments, the amount of resin poured into the mold is specifically selected so that the resin does not completely fill the mold. In this manner, room remains in the mold for the addition of glass fragments and additional resin that encases the glass fragments in the resin.

In some embodiments, the resin is poured into a mold that includes a sheet of material already placed in the mold. In doing so, the resin poured into the mold can take on some of the characteristics of the sheet of material placed in the mold prior to adding the resin. Any suitable material can be placed in the mold prior to adding the resin. Exemplary materials include, but are not limited to, acrylic sheets, polycarbonate sheets, and PETG sheets. The resin material poured on materials such as these can bond with the materials and take on characteristics of the materials such as strength and color.

In step 130, glass fragments are placed in the mold on top of the resin poured into the mold in step 120. The glass fragments will eventually be covered with additional resin so as to be encased in the resin material. After the resin material hardens in the shape of the mold, the finished product will have the glass fragments embedded within the three-dimensional element.

The source of the glass fragments placed in the resin is not limited. In some embodiments, the glass fragments are obtained from post-consumer glass. In this manner, the finished product beneficially uses recycled material and reduces the amount of waste that will end up in a landfill. Post-consumer glass can include discarded windshields, bottles, and windows, among any other consumer product that uses glass and is eventually discarded. The glass fragments can also be obtained from scraps produced during the manufacture of other products that use glass. For example, the process of tempering glass can result in substantial amounts of scrap glass that can then be used in step 130.

The color of glass fragments used in step 130 can be any color glass is available in. In some embodiments, the color of the glass is dictated by the color of the post-consumer glass available for use in the three-dimensional elements. When the glass used is not post-consumer glass, the glass fabricated or purchased for use in the three-dimensional elements can be chosen from any color.

Regarding size, the glass fragments can be any suitable size for use in the three-dimensional elements. In some embodiments, the only limiting factor for the size of the glass fragments is the size of the molds being used to create the three-dimensional element. That is to say, the glass fragments used in the process should not be larger than the depth or width of the mold and should allow for the resin to fully encase the glass fragments. In some embodiments, the glass fragments preferably range in size from about 400 mesh screen to about one inch.

In some embodiments, the glass fragments used in three-dimensional elements are the same color and approximately the same size. However, the glass fragments can also he a variety of different colors and can have varying sizes.

The quantity of glass fragments placed in the resin can by any suitable amount, and can vary based on the desired aesthetic of the finished product. The ability to use molds having a wide variety of shapes and sizes means that more glass fragments can be used in the element than is traditionally possible with the flat panels produced by extrusion and pultrusion methods. Correspondingly, the three-dimensional molds available for use in the methods described herein provide greater space for glass fragments, which allows for glass fragments to be embedded at larger depths within the element. Both of these features can provide three-dimensional elements having a deeper, richer, more attractive appearance then elements produced by the extrusion and pultrusion methods.

In some embodiments, it is preferable that the quantity of glass fragments placed in the resin does not completely fill the mold. In this manner, space remains in the mold for adding additional resin that will encase the glass fragments.

While glass fragments are the preferable material for being placed in the resin material and embedded within the finished product, many other suitable materials can be used. Exemplary materials that can be used in place of or in addition to, glass fragments include, but are not limited to, marbles, stones, beads, wood chips, metal fragments, gears, springs, and circuit boards.

In some embodiments, steps 130 and 120 may be reversed such that glass fragments are placed in the mold prior to adding any resin material to the mold.

In step 140, an additional amount of resin is poured into the mold. In some embodiments, the resin used in step 140 is identical to the resin prepared in step 110 and poured into the mold in step 120. Accordingly, this resin can be prepared in a similar or identical manner to the preparation step described in step 110 and can be poured into the mold in the same manner as described in step 120.

In some embodiments, the resin added to the mold in step 140 is different than the resin prepared in step 110. The resin used in step 140 can be different from the resin prepared in step 110 in one or more ways. For example, the resin used in step 140 can be dyed a different color than the resin used in step 110 or can be mixed with a different amount and/or type of catalyst or hardener. However, it is preferable that the resin material used in step 140 be of a type that will polymerize with the resin prepared in step 110 so that curing of the material poured into the mold will lead to bonding between the two different types of resin and encasing of the glass fragments between the two different resin layers.

The amount of resin poured into the mold in step 140 can be any suitable amount of resin that will at least partially encase the glass fragments placed in the mold in step 130. In some embodiments, the amount of resin poured into the mold in step 140 is sufficient to completely cover the glass fragments with resin material. In some embodiments, the amount of resin poured into the mold in step 140 is sufficient to fill the remaining space in the mold. By adding this amount of resin to the mold, a finished product having the desired shape and size of the mold can be assured.

After an additional amount of resin has been poured into the mold to encase the glass fragments, a step 150 of curing the resin material poured into the mold is carried out. The step 150 of curing the resin material is carried out so that the resin material in the mold polymerizes and converts from a liquid material to a hardened solid material having glass fragments embedded therein. Curing of the resin material in the mold can be carried out by any suitable curing technique known to those of ordinary skill in the art. In some embodiments, the curing step entails subjecting the resin-filled mold to elevated temperatures. The elevated temperature to which the resin-filled molds are exposed can depend on the type of resin used and at what temperature the resin begins to polymerize. In some embodiments, the resin-filled mold is subjected to a temperature in the range of from 65° F. to 210° F. in order to carry out the curing stage. Other suitable curing techniques include, but are not limited to, exposing the resin-filled mold to air and exposing the resin-filled mold to ultraviolet radiation or electron beams.

The curing step 150 can be carried out for any suitable period of time required for the resin material to polymerize and harden into a solid structure. The amount of time required for sufficient curing can be affected by factors such as the temperature used to conduct the curing step. For example, curing at higher temperatures may decrease the overall amount of time required for the curing step, and curing at lower temperatures may increase the overall amount of time for the curing step. In some embodiments, the curing step takes place for about 3 hrs to about 24 hrs.

In step 160, the solid glass-filled resin element is demolded from the mold. Any manner for removing the finished product from the mold that will not result in causing significant damage to the finished product can be used. In some embodiments, such as when a silicone rubber mold is used, the finished product may be relatively easy to remove from the mold due to the lack of any type of reaction or adhesion between the resin material and the mold. In such cases, the mold can, for example, be slowly turned upside down so that the finished product falls gently out of the mold under the force of gravity. The finished product can be allowed to fall out of the mold onto a soft surface, such as a cushion, to help ensure the finished product is not damaged during demolding. Similarly, an individual turning the mold upside down can place their hand on the finished product so that the finished product does not demold from the upside down mold until the individual lowers their hand away from the upside down mold. In some embodiments, the mold can be broken away from the finished product. For example, when a wood frame is used as the mold as described in greater detail above, the wood frame can be broken away from the finished product to demold the solid glass-filled resin element.

After the finished product has been safely demolded, an inspection of the finished product can take place to see if any surface blemishes or imperfections appear on the finished product. If any surface imperfections exist, a step 170 of buffing and/or polishing the finished product can take place to correct the surface imperfections. The ability to buff or polish the finished product without causing further damage to the finished product represents another advantage over the previously know methods of using pultrusion or extrusion processes to create glass-filled resin elements. In Applicant's experience, glass-filled resin elements produced by a pultrusion or extrusion process cannot be buffed without causing further surface damage to the element. However, in the methods described herein, the finished product can be polished or buffed to correct any defects without causing further damage to the element.

Any suitable process for buffing or polishing the surface of the glass-filled resin elements to remove surface imperfections can be used. In some embodiments, the buffing or polishing can be conducted manually, such as by manually rubbing an abrasive buffing cloth against the surface of the element. Similarly, polishing can be carried out manually using any suitable polishing substance. In some embodiments, the buffing or polishing is carried with the use of industrial machinery.

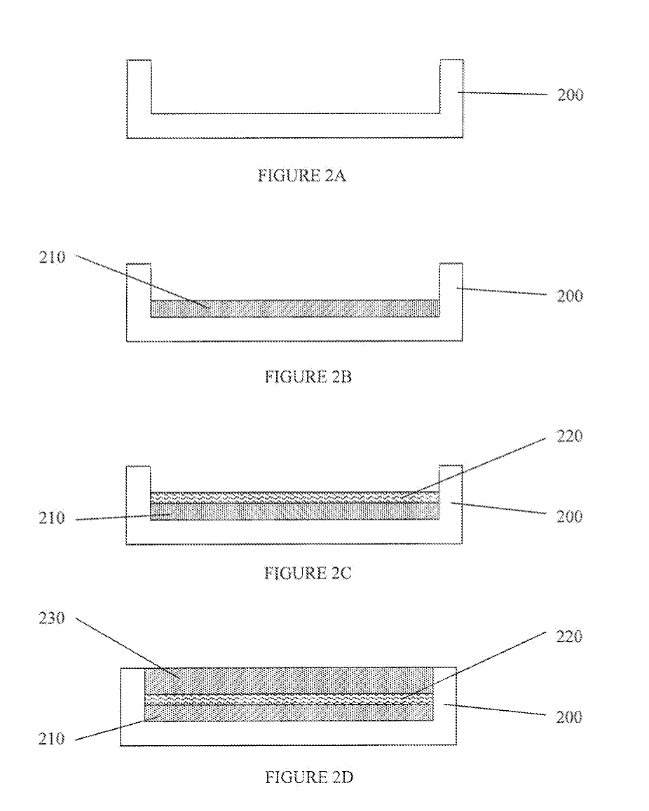

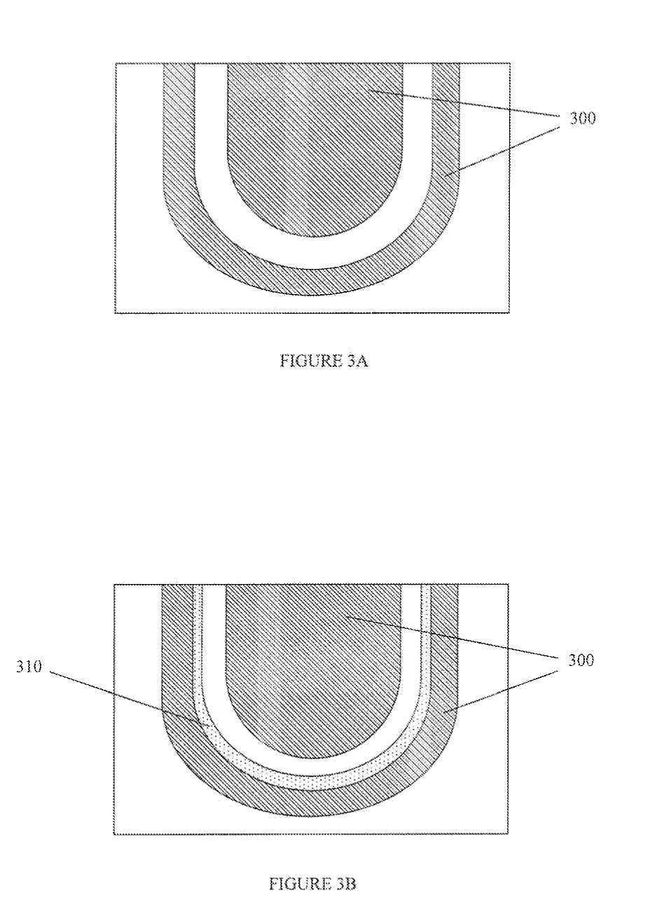

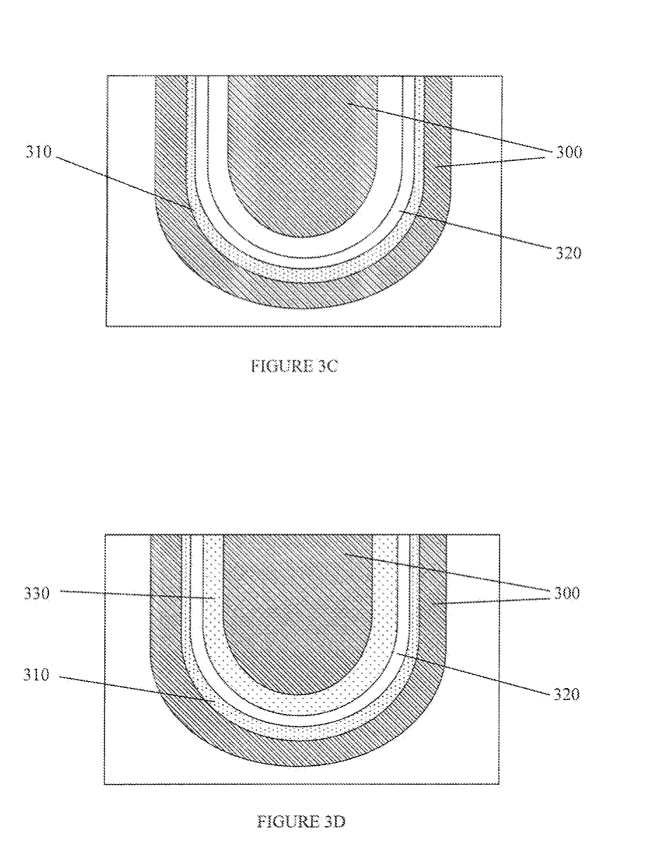

With reference to FIGS. 2A-D, a method including several of the steps described in greater detail above begins with providing a silicone rubber mold 200 as shown in FIG. 2A. The silicone rubber mold 200 can be an open mold having any size and shape, although the mold shown in FIG. 2A is a flat, open mold that will produce a glass-filled resin element that is a flat panel.

With reference to FIG. 28, a prepared resin material 210 is poured into the open silicone rubber mold 200. The resin material 210 can be prepared by mixing together a suitable transparent thermosetting resin material with a catalyst material that will help to harden the resin material during the curing stage. After the catalyst and the resin are mixed, the resin material can be introduced into a vacuum chamber to degas the resin material and remove air bubbles from the resin material.

As shown in FIG. 2B, the amount of prepared resin material 210 poured into the open mold 200 is less than will fill the entire mold 200 so that glass fragments and additional resin material can be added to the mold 200 in subsequent steps. The relatively thin layer of prepared resin material 210 fills the area within the mold 200 clue to the liquid nature of the prepared resin material 210.

With reference to FIG. 2C, glass fragments 220 are placed in the mold 200 on top of the relatively thin layer of prepared resin material 210. The glass fragments 220 added into the mold 200 can be different sizes and colors, or can be more uniform. The glass fragments 220 can be made from post consumer glass, although the glass may have other sources. As shown in FIG. 2C, the amount of glass fragments 220 used is less than will fill the mold 200 so that space remains for the addition of a second amount of resin that will encase the glass fragments 220.

With reference to FIG. 2D, additional prepared resin material 230 poured into the mold 200 fills the remainder of the mold 200 and encases the glass fragments 220. The mold 200 now filled with resin 210, 230 and glass fragments 220 is cured so that the resin material 210, 230 hardens and forms a solid structure having glass fragments 220 embedded therein. The solid element thus formed is removed from the mold 200 and can be polished and/or buffed to create the final product.

With respect to FIGS. 3A-3D, a similar method to the one described above and illustrated in FIGS. 2A-2D is shown, with the exception that a intricately dimensional silicone rubber mold 300 is used in place of the flat panel mold shown in FIGS. 2A-2D. The process of using the intricately dimensional silicone rubber mold 300 proceeds similarly to the method shown in FIGS. 2A-2D, with a prepared resin material 310 being poured into the mold 300 (FIG. 3B), glass fragments 320 being placed into the mold 300 on top of the resin 310 (FIG. 3C), and additional resin 330 being added to the mold 300 to encase the glass fragments 320 (FIG. 3D). Curing then takes place to harden the resin 310, 330 and create a solid glass-filled resin structure having the intricately dimensional shape of the silicone rubber mold 300. From FIGS. 3A-3D, it becomes evident that methods described herein are capable of producing custom three-dimensional elements in virtually any shape and size, as opposed to only the flat panels that can be produced by the extrusion and pultrusion methods.

As discussed above, the glass-filled three-dimensional resin element produced by the methods described above generally include a solid structure of cured resin material having glass fragments embedded within the structure. The solid structures are translucent and can diffuse and alter the color of light to provide pleasing aesthetic designs. Light passing through the elements can be altered both by the glass fragments embedded in the resin material and the resin material itself. Additionally, the ability to use colored glass and colored resin provides elements that can alter the color of the light passing through the elements and provide a variety of ambiences. When the glass fragments are from post-consumer glass, the resin elements also help to reduce waste.

As also mentioned above, the glass-filled three-dimensional elements can be made in any variety of shapes and sizes. Specifically, the elements can be produced in three-dimensions, allowing for a variety of options in depth, width and height. The ability to provide an element that is three-dimensional allows for further artistic features of the produced elements due to the extra space available within the elements themselves. For example, in flat panel sheets produced by extrusion and pultrusion processes, the depth dimension of the element is limited, which in turn limits the amount of glass fragments that can be embedded in the element and how the glass fragments can be arranged. Conversely, three-dimensional elements described herein can embed more glass fragments and can arrange the glass fragments in the depth dimension, giving the resulting element a deeper, richer appearance.

Another feature of the glass-filled three-dimensional resin elements described herein is the wide variety of colors that can be used in the finished product. The color of the glass fragments used in the elements can be any available glass color, and the resin material used in the elements can be dyed to take on any color or can be left transparent to more prominently feature the embedded glass fragments. The flexibility of the elements with respect to colors used adds another advantageous design option to the elements that is not possible with elements produced by other methods.

We claim:

1. A method of making glass-filled resin elements, the method comprising:
providing a mold;
pouring a first quantity of a resin material into the mold;
adding glass fragments into the mold;
pouring a second quantity of the resin material into the mold; and
curing the resin material in the mold and forming a glass-filled resin element.

2. The method as recited in claim 1, further comprising:
removing the glass-filled resin element from the mold; and
polishing or buffing the glass-filled resin element.

3. The method as recited in claim 1, wherein the mold is a curvilinear three-dimensional mold.

4. The method as recited in claim 1, wherein the mold is a silicone rubber mold.

5. The method as recited in claim 1, wherein the mold is a closed mold and the method further comprises rotating the mold in multiple directions after pouring the first resin into the mold.

6. The method as recited in claim 1, wherein the resin material comprises polyester resin, polyurethane rein, or epoxy resin.

7. The method as recited in claim 1, wherein the resin material comprises a fire retardant resin.

8. The method as recited in claim 1, wherein the resin material comprises a liquid catalyst.

9. The method as recited in claim 1, wherein the resin material comprises a dye.

10. The method as recited in claim 1, wherein the method further comprises:
degassing the resin material prior to pouring the resin material into the mold.

11. The method as recited in claim 1, wherein the glass fragments comprise recycled glass material.

12. The method as recited in claim 1, wherein curing the resin material is carried out at from 65° F. to 210° F.

13. A method of making glass-filled resin elements, the method comprising:
providing a curvilinear three-dimensional mold;
pouring a first resin material into the curvilinear three-dimensional mold, the first resin material comprising a first dye;
adding glass fragments into the mold;
pouring a second resin material into the curvilinear three-dimensional mold, the second resin material comprising a second dye;
curing the first resin material and the second resin material and forming a three-dimensional glass-filled resin element.

14. The method as recited in claim 13, wherein the first resin material is a different resin material from the second resin material.

15. The method as recited in claim 13, wherein the first dye is a different color from the second dye.

16. The method as recited in claim 13, further comprising:
removing the three-dimensional glass-filled resin element from the mold; and
buffing or polishing the three-dimensional glass-filled resin element

17. The method as recited in claim 13, wherein the first resin material and second material are fire retardant resin material.
